(19) United States
(12) Patent Application Publication
(10) Pub. No.: US 2025/0093966 A1
(43) Pub. Date: Mar. 20, 2025

(54) Customizable Human Interface Device

(71) Applicant: LENOVO (SINGAPORE) PTE. LTD., Singapore (SG)

(72) Inventors: Andy Tuan Hang, Morrisville, NC (US); Liam Fox, Morrisville, NC (US)

(73) Assignee: LENOVO (SINGAPORE) PTE. LTD., Singapore (SG)

(21) Appl. No.: 18/369,055

(22) Filed: Sep. 15, 2023

(51) Int. Cl. G06F 3/02; G06F 3/023; H01H 13/7073; H01H 13/83

(52) U.S. Cl. CPC G06F 3/0219; G06F 3/0216; G06F 3/0238; H01H 13/7073; H01H 13/83

(57) ABSTRACT

A device can include an elastic membrane; an array that includes translatable elements extendable to elastically deform the elastic membrane to form a customizable arrangement of discrete keys; and sensor circuitry that senses actuation of each of the discrete keys.

### TECHNICAL FIELD

Subject matter disclosed herein generally relates to human interface device technology for computing systems or other systems.

### BACKGROUND

A keyboard is a type of human interface device (HID) that may include an arrangement of keys such as, for example, a QWERTY layout. Such a keyboard may be utilized as a HID for a computing system or one or more other systems. For example, consider a standardize PC-compatible keyboard, which may include a separate numeric keypad for data entry to a right side, a number of function keys at a top side, and a cursor section to a right side, along with keys for Insert, Delete, Home, End, Page Up, and Page Down. A standardized PC-compatible keyboard may be suitable for a two-handed individual with full, five finger dexterity of each hand. Such an individual may also be expected to have suitable arm mobility to effectively use of a standardized PC-compatible keyboard.

### SUMMARY

A device can include an elastic membrane; an array that includes translatable elements extendable to elastically deform the elastic membrane to form a customizable arrangement of discrete keys; and sensor circuitry that senses actuation of each of the discrete keys. Various other apparatuses, systems, methods, etc., are also disclosed.

### BRIEF DESCRIPTION OF THE DRAWINGS

Features and advantages of the described implementations can be more readily understood by reference to the following description taken in conjunction with examples of the accompanying drawings.

FIG. 1 is a diagram of an example of a device;

FIG. 2 is a diagram of an example of a device;

FIG. 3 is a diagram of an example of a display;

FIG. 4 is a diagram of an example of a device;

FIG. 5 is a diagram of an example of a device;

FIG. 6 is a diagram of an example of an array;

FIG. 7 is a diagram of an example of an array;

FIG. 8 is a diagram of an example of an array;

FIG. 9 is a diagram of an example of an array;

FIG. 10 is a diagram of an example of a method;

FIG. 11 is a diagram of an example of a graphical user interface;

FIG. 12 is a diagram of an example of a device;

FIG. 13 is a diagram of an example of a translatable element; and

FIG. 14 is a diagram of an example of a system that includes one or more processors.

### DETAILED DESCRIPTION

The following description includes the best mode presently contemplated for practicing the described implementations. This description is not to be taken in a limiting sense, but rather is made merely for the purpose of describing general principles of various implementations. The scope of invention should be ascertained with reference to issued claims.

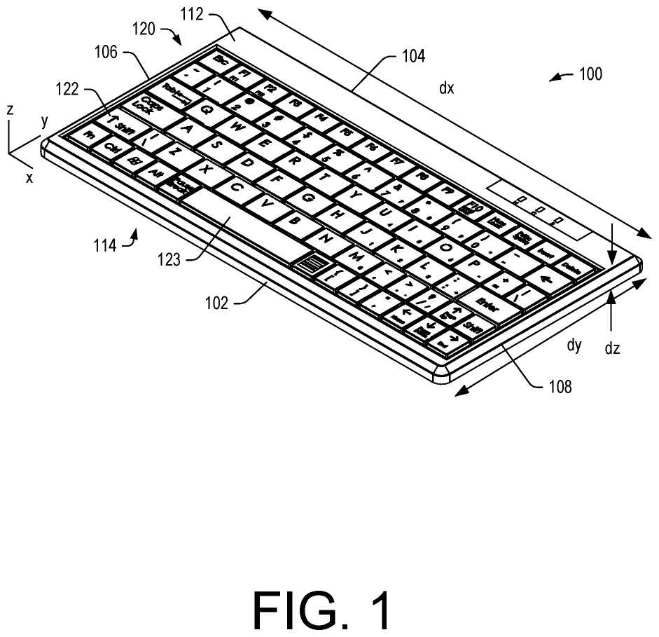

FIG. 1 shows an example of a keyboard 100, which, as mentioned, may be a human interface device (HID). As shown, the keyboard 100 may be defined with respect to a Cartesian coordinate system with x, y and z axes and may include a front edge 102, a back edge 104 and opposing left side and right side edges 106 and 108 where the front edge 102 and the back edge 104 may be of a length dx while the side edges 106 and 108 are of a length dy such that the keyboard 100 has a generally rectangular shape. As shown, the keyboard 100 can have a top surface 112 and a bottom surface 114 that may define a thickness such as, for example, a thickness dz, which may be constant. In such an example, the keyboard 100 may occupy a volume given by a product of dx, dy and dz. For example, the keyboard 100 may have a substantially cuboid shape. A cuboid may be defined as a closed box composed of three pairs of rectangular faces placed opposite each other and joined at right angles to each other, also known as a rectangular parallelepiped.

In the example of FIG. 1, the keyboard 100 is shown as including keys 120, where an individual key 122 is identified, for example, as a shift key. As shown, the keys 120 may have a QWERTY layout along with function keys and various other keys that may be standard PC keys. The layout of the keys 120 includes a spacebar 123, as a key that is at the bottom edge 102 and substantially centered between the edges 106 and 108. The spacebar 123 may be accessible using standardized touch-typing by either or both of a left thumb and a right thumb of a user where fingers of the user's right hand and left hand extend toward the back edge 104 and over the keys 120 for touch-typing.

On a standard QWERTY keyboard for the English language, home row keys are ASDF for the left hand and JKL for the right hand. Various keyboards may include a raised dot or bar on one or more of the home keys, for example, for index fingers to help touch typists maintain and rediscover proper positioning of fingers on the keyboard keys.

As explained, a keyboard such as the keyboard 100 may be configured with an assumption that an individual has two-hand dexterity and that the individual may be a touch-typist.

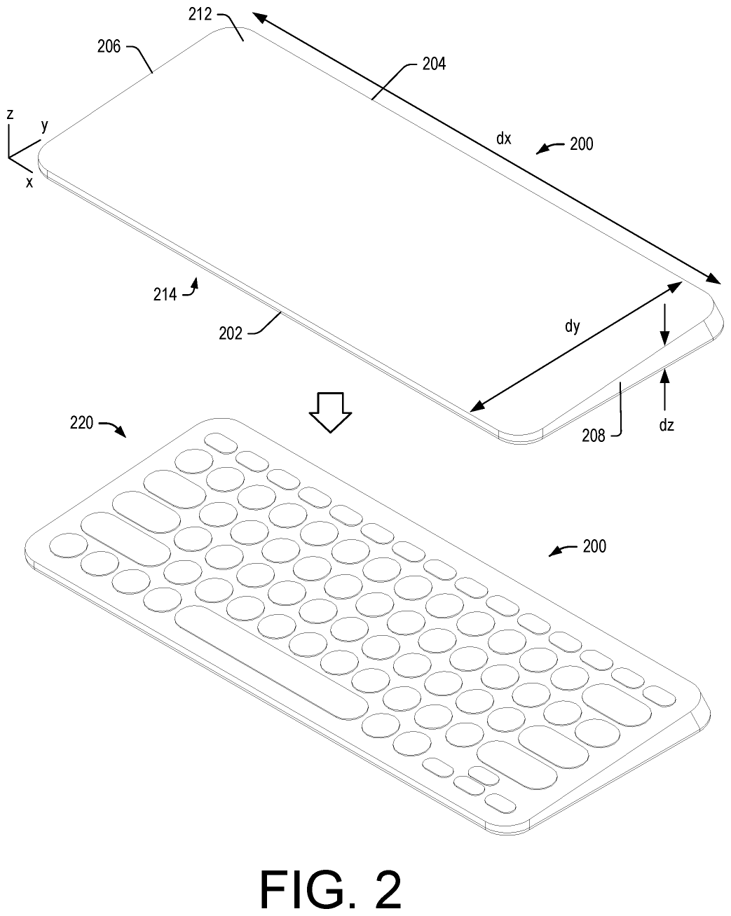

FIG. 2 shows an example of a device 200, which may be a human interface device (HID). As shown, the device 200 may be defined with respect to a Cartesian coordinate system with x, y and z axes and may include a front edge 202, a back edge 204 and opposing left and right side edges 206 and 208 where the front edge 202 and the back edge 204 may be of a length dx while the side edges 206 and 208 are of a length dy such that the device 200 may have a generally rectangular shape. As shown, the device 200 can include a top surface 212 and a bottom surface 214 that may define a thickness such as, for example, a thickness dz, which may be constant or may vary (e.g., between the edge 202 and the edge 204). As an example, the device 200 may occupy a volume given by a product of dx, dy and dz. For example, the device 200 may have a substantially cuboid shape. A cuboid may be defined as a closed box composed of three pairs of rectangular faces placed opposite each other and joined at right angles to each other, also known as a rectangular parallelepiped.

While a cuboid shape is mentioned with respect to the example of FIG. 2, the device 200 may have a different shape such as, for example, a polygonal shape, a curved shape, etc. As an example, the device 200 may have a circular shape, an oval shape, a boomerang shape, etc.

In the example of FIG. 2, the device 200 is shown in a blank state and in a customized state with keys 220. As shown, the blank state may be without keys and the customized state can include the keys 220 that may automatically be generated by the device 200 responsive to a signal. For example, consider an electric signal that may be received by the device 200, generated responsive to touching of the device 200, etc., such that the device 200 transitions from the blank state to the customized state.

In the example of FIG. 2, the customized state may involve generating keys that may be customized to conform to keys of a standard type of keyboard or, for example, they may be customized to another arrangement or a hybrid arrangement.

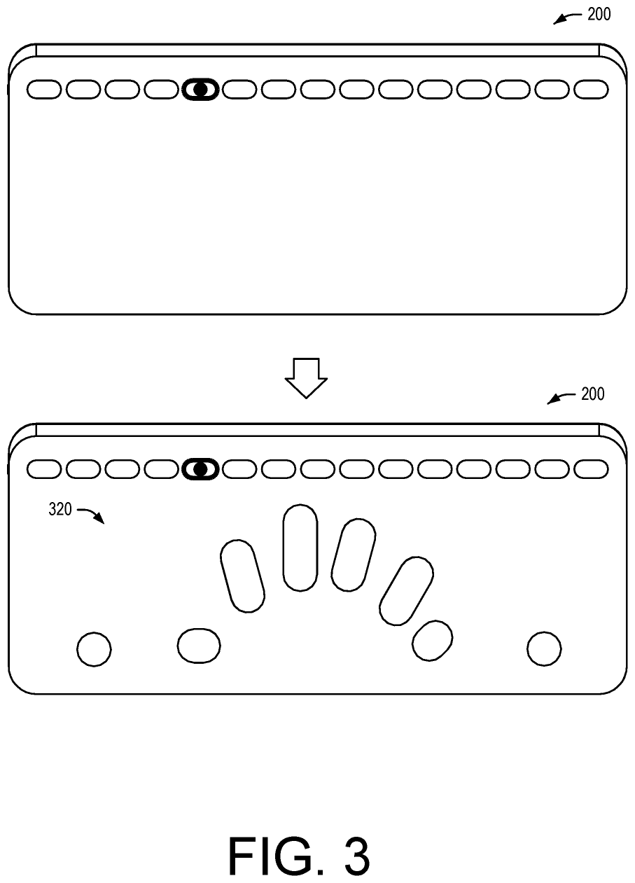

FIG. 3 shows an example of the device 200 as including a number of keys, which may, for example, be actuatable via touch to cause the device 200 to transition from a blank state of a portion of the device 200 to a customized state of the portion of the device 200. For example, consider the number of keys as being associated with different arrangements of keys where such keys may be customized as to one or more of shape, layout, function, etc.

In the example of FIG. 3, the keys 320 may be associated with one of the number of keys as shown near the back edge 204. As an example, the device 200 may include a microphone and voice recognition circuitry such that a user may utter a verbal command that causes the device 200 to transition from one state to another state (e.g., from a blank state to a customized state, from one customized state to another customized state, etc.). Thus, while the example of FIG. 3 shows the number of keys, for example, to transition from one state to another, the device 200 may be operable without such keys. As an example, a device may be a customizable HID that may include one or more mechanisms for transitioning from one state to another state. As explained, one mechanism may be via touch, another mechanism may be via a voice command, etc.

As to the particular layout of the keys 320 in the customized state of the device 200, the layout may be for a single-handed user where, for example, the user may utilize fingers of her right hand to touch one or more of the keys 320. In such an example, the user may place her fingers of her right hand over a corresponding number of the keys 320 such that touching and/or depressing one or more of the keys 320 (e.g., discretely, simultaneously, etc.) causes a desired input to the device 200, which may result in corresponding output (e.g., HID output).

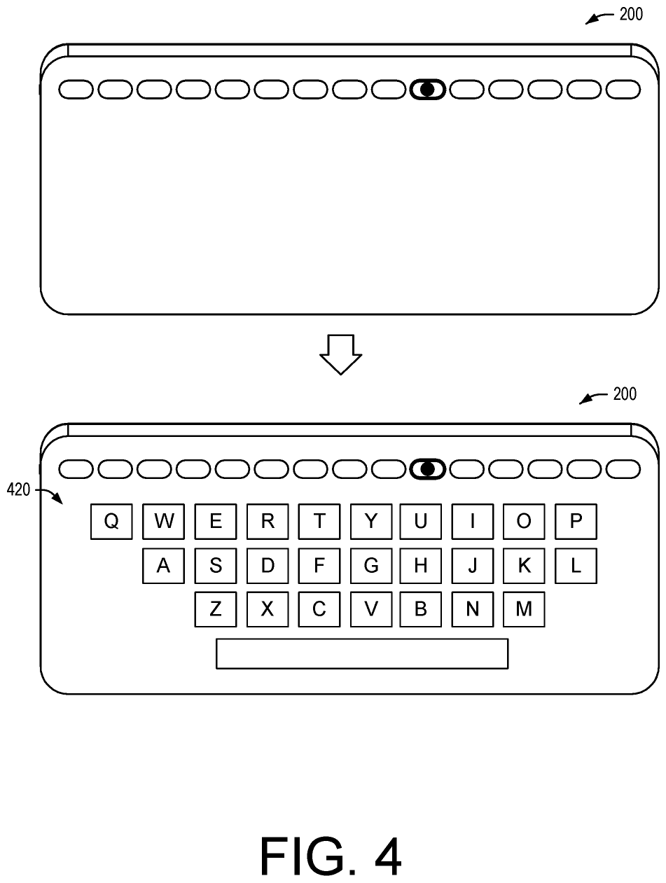

FIG. 4 shows an example of the device 200 where upon actuation of another one of the number of keys, a different layout of keys 420 is generated, which may include a QWERTY layout. Thus, the device 200 may be customizable for use with one or more layouts where, for example, a layout may be stored in memory and generated responsive to a signal (e.g., a touch, a voice command, etc.).

As an example, with the layout of keys 320 and the layout of keys 420, the device 200 may be suitable for use by multiple individuals where, for example, one individual uses the layout of keys 320 and another individual uses the layout of keys 420. In such an example, the device 200 may be in communication with a computing system (e.g., a computer) such that different individuals with different preferences may utilize the device 200 as a HID where, for example, the different preferences may be associated with different capabilities of the individuals (e.g., as to dexterity, etc.).

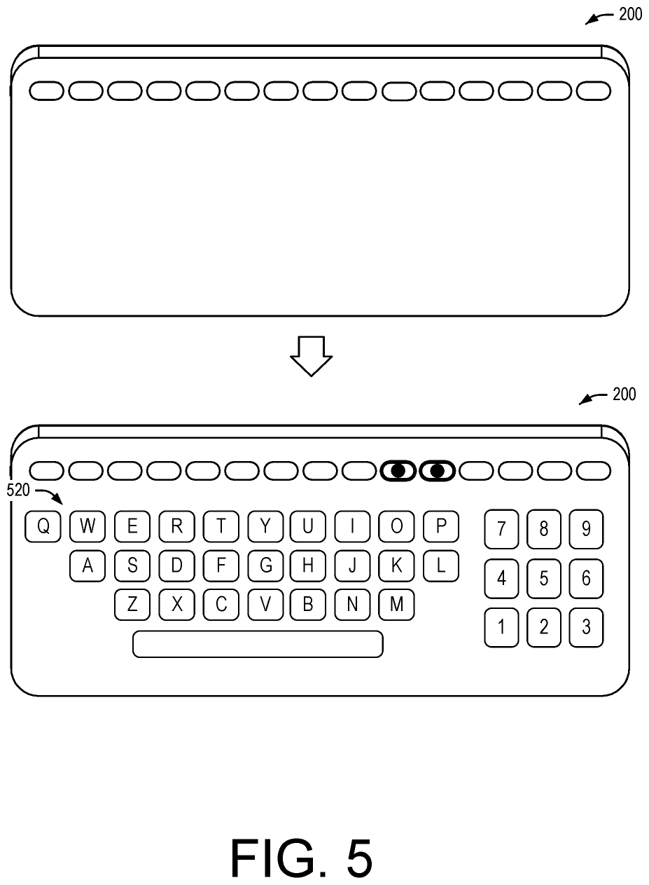

FIG. 5 shows an example of the device 200 where upon actuation of another one of the number of keys, a different layout of keys 520 is generated, which may include the QWERTY layout of the keys 420 and an additional layout of keys such as a numeric keypad layout to thereby define the layout of keys 520. In such an example, a combination of the number of keys may be actuated where one of the number of keys calls for generation of a QWERTY layout and another one of the number of keys call for generation of a numeric keypad where, for example, the layouts are automatically sized and positioned to accommodate the keys associated with each of the layouts. In such an example, the number of keys may be selected to provide for various customized layouts, which may be combinations of customized base layouts.

As an example, one or more application programming interfaces may be utilized to acquire information and/or to send information about a customized HID. For example, consider one or more WINDOWS operating system APIs (Microsoft Corporation, Redmond, Washington). As an example, consider the following code:

```
HKL ActivateKeyboardLayout(
  [in] HKL hkl,
  [in] UINT Flags
);
```

As an example, an API may provide for setting the input locale identifier (e.g., formerly called the keyboard layout handle) for a calling thread or a current process. In such an example, the input locale identifier may specify a locale as well as the physical layout of the keyboard. In such an example, upon selection of a particular customized layout, a device may transmit a signal that provides information as to layout and/or that prompts a call as to layout.

As another example, consider

```
HKL LoadKeyboardLayoutA(
  [in] LPCSTR pwszKLID,
  [in] UINT Flags
);
```

In the foregoing example, the type LPCTSTR is the name of the input locale identifier to load. This name is a string composed of the hexadecimal value of the Language Identifier (low word) and a device identifier (high word). For example, US English has a language identifier of 0x0409, so the primary US English layout is named “00000409”. Variants of US English layout (such as the Dvorak layout) are named “00010409”, “00020409”, etc.

As an example, a method may provide for a translation table or transformation table to handle customized HID functions and mapping such functions to appropriate functions of a computing system. As an example, a method may include using one or more registry keys for linking to one or more types of keyboard or HID layouts. In such an approach, a device, upon being operatively coupled with a computing system may download or otherwise cause installation of appropriate listings, mappings, transformations, etc., such that a customized HID may be utilized with a particular computing system and its operating system.

As an example, a computing system may include a keyboard controller where a customizable HID may be configured to provide output to the keyboard controller. As an example, the customizable HID and/or the computing system may include one or more types of circuitry to handle customization of a customizable HID such that signals may be processed appropriately by a keyboard controller of a computing system (e.g., consider a WINDOW keyboard controller).

As an example, a device such as a customizable HID device may include one or more wired and/or wireless interfaces. For example, consider a serial interface that may provide for one or more of data and power. As an example, a wireless interface may be a relatively low power interface such as, for example, a BLUETOOTH interface. As an example, a customizable HID may be pairable with a computing system using a BLUETOOTH interface. As an example, a customizable HID may include a battery and/or may receive power via a cord, an antenna, etc.

In the examples of FIG. 2, FIG. 3, FIG. 4 and FIG. 5, various layouts are shown 220, 320, 420 and 520 that may be generated by the device 200. As to generation of the layouts, as an example, the device 200 may include an elastic membrane; an array that includes translatable elements extendable to elastically deform the elastic membrane to form a customizable arrangement of discrete keys; and sensor circuitry that senses actuation of each of the discrete keys.

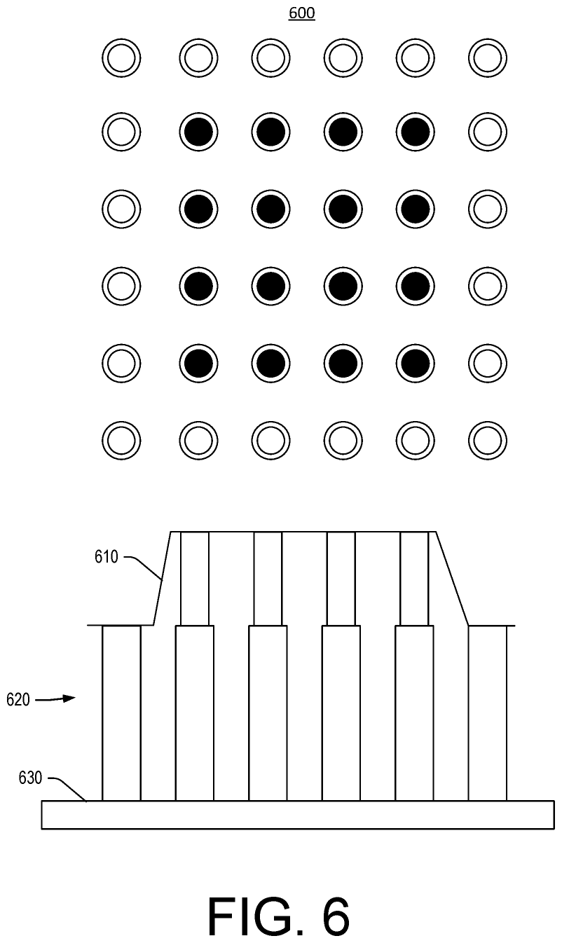

FIG. 6 shows an example of an array 600 that may be a pixel or dot type of array. As shown, the array 600 may include translatable elements 620 operatively coupled to control circuitry 630 where the translatable elements 620 are extendable to elastically deform a membrane 610. For example, a key may be defined by actuation of a group of the translatable elements 620 to form a rectangular shaped key where, for example, the key may be generated with a marker, which may be a marker as to function of the key upon actuation. For example, consider a marker for a character, a particular function (e.g., a function key), a space, a return, navigation, etc.

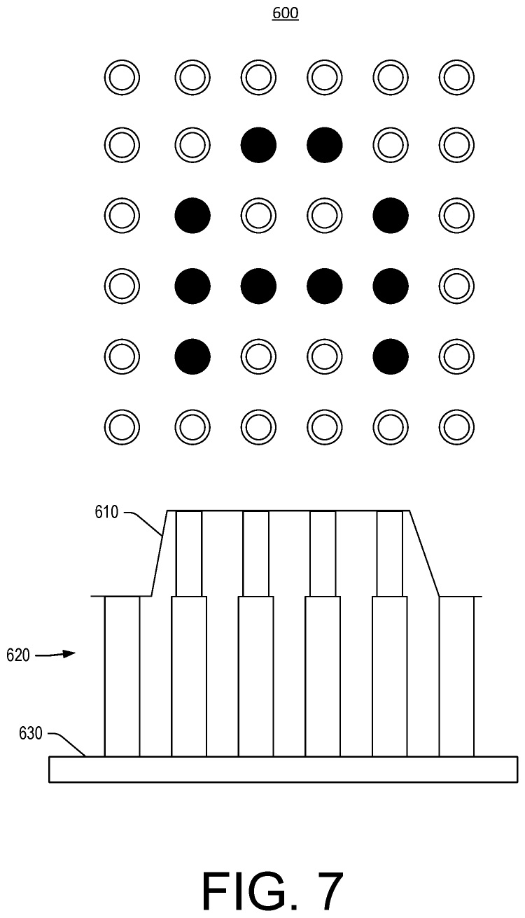

FIG. 7 shows the example array 600 of FIG. 6 where a marker for the letter “A” is generated. For example, the array 600 may include translatable elements 620 that may also provide for colors, light, texture, etc. For example, as to color, an end of a translatable element may be of a particular color that may differ from a background color. As to light, a translatable element may include an LED, a lightpipe in communication with a light source, etc. As to a texture, a translatable element may define a marker (e.g., a character, etc.) by extending further a distance above one or more other translatable elements and/or by extending to a distance below one or more other translatable elements. As an example, a marker may be a visible marker and/or a touch-detectable marker. For example, a sighted user may see the letter “A” in the example of FIG. 7 as a consequence of color, light, texture, etc. As to a touch-detectable marker, as mentioned, a texture may be formed.

As an example, a touch-detectable marker may be a coded marker such as, for example, a braille-coded marker that differs from a marker as to a standard character (e.g., a Latin character, an Eastern Asian character, etc.). In braille, letters may be coded using an array with two columns and three rows (e.g., 2×3). In braille, the letter “A” may be coded using the member of the array that is at the top left, in the first column and the first row. Thus, a device may be customizable to generate a marker or a coded marker. For example, a device may be customizable to generate the “A” as shown in the example of FIG. 7 or to generate an “A” as in the braille alphabet. In such an approach, the device 200 may be suitable to facilitate use by sighted and non-sighted users.

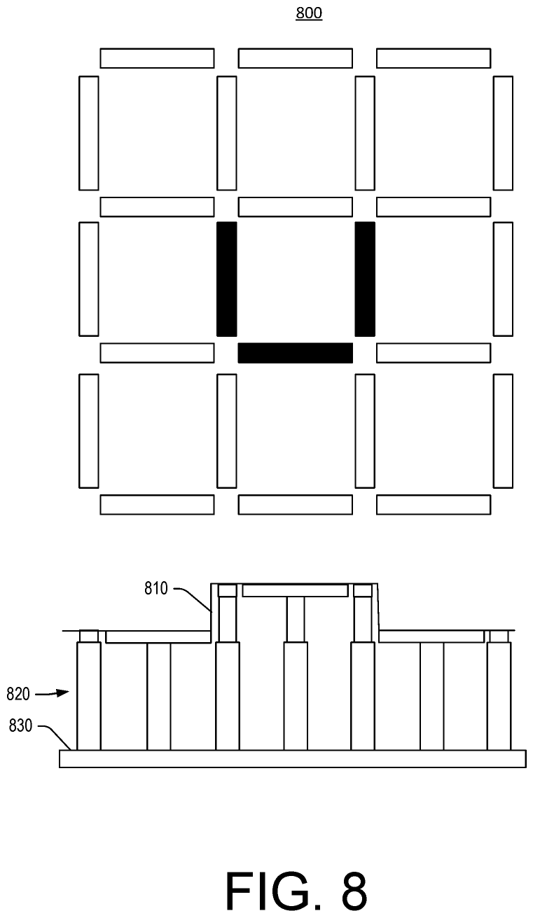

FIG. 8 shows an example of another array 800, which may be referred to as a segment type of array. For example, consider a so-called 7 segment array; noting that one or more other types of segment arrays may be utilized.

In the example of FIG. 8, the array 800 may include oriented segments as translatable elements 820 that can be raised and lowered as desired per customization to generate a key or keys. In such an example, a membrane 810 may be included that can be deformed elastically to form a key. In the example of FIG. 8, the translatable elements 820 may be colored, lighted, etc., for example, to generate a marker or markers. In the example of FIG. 8, the array 800 may generate a key with a marker for the letter “U”. For example, three segments of the translatable elements 820 may be raised by control circuitry 830 where the three segments may be illuminated and/or otherwise colored, shaded, etc., to form the letter “U” using the three segments. In such an example, one or more other segments may be utilized to form a key, which may not be illuminated and/or otherwise colored, shaded, etc. and/or which may be differently illuminated and/or otherwise colored, shaded, etc. In various examples, a marker may be formed in a tactile manner, for example, via control of a surface of a segment. For example, consider a surface of a segment that forms at least part of a marker that may be roughened via actuation of surface features (e.g., mechanical, etc.) and/or that may be raised slightly higher than a segment that forms a key but not part of the marker. In such an approach, an individual may tactilely discern a marker and hence function of a key.

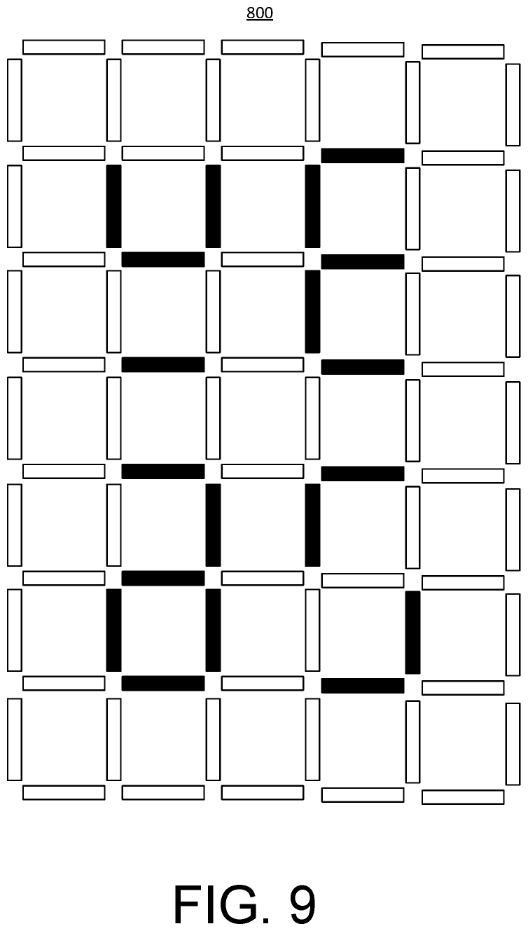

FIG. 9 shows an example of the array 800 where markers may be generated according to the Siekoo alphabet. As an example, the Siekoo alphabet may also be utilized where 7-segment characters are tactilely detectable. In such an approach, the Siekoo alphabet may be utilized for individuals that are vision impaired. In the example of FIG. 9, the keys generated include W, E, A and S, which may be arranged in a layout akin to a QWERTY layout. As explained, translatable elements may be extended according to instructions to form a customized HID (e.g., keyboard, etc.) where an elastic membrane may be positioned over ends of the translatable elements to form raised keys. As an example, some translatable elements may be utilized as anchors such that an elastic membrane forms a tented shape, for example, via translatable elements that operation as anchors and support poles. In the example of FIG. 9, various segments disposed between the keys may operate as anchors to maintain the elastic member at a lower elevation (or elevations) while other segments maintain the elastic membrane at an upper elevation (or elevations). In such an approach, a customizable HID can contour an elastic membrane to form a HID with a customized layout of keys.

As an example, an elastic membrane may be elastically deformable over a number of cycles to form keys. As an example, an elastic membrane may be elastically deformable to provide a rise in elevation, for example, of approximately 0.05 cm to 5 cm over a base elevation. In such an example, two adjacent keys may be spaced a distance, for example, of approximately 0.1 mm or more, which may depend on a resolution of an array. For example, an array may have a resolution defined by how translatable elements are arranged, which may be in rows and columns, noting that different arrangements may depend on type of translatable element and/or end shape of a translatable element.

As mentioned, the Siekoo alphabet may be utilized by a customizable HID. The Siekoo alphabet provides for representation of Latin letters using 7 segments that may be encoded using seven bits. As an example, a segment type of array may provide for efficiently representing keys of Latin letters, which may be discernable by sight and/or touch (e.g., tactilely). As example, control circuitry may provide for 7 segment-based keys, for example, according to the Siekoo alphabet and/or one or more other alphabets, etc.

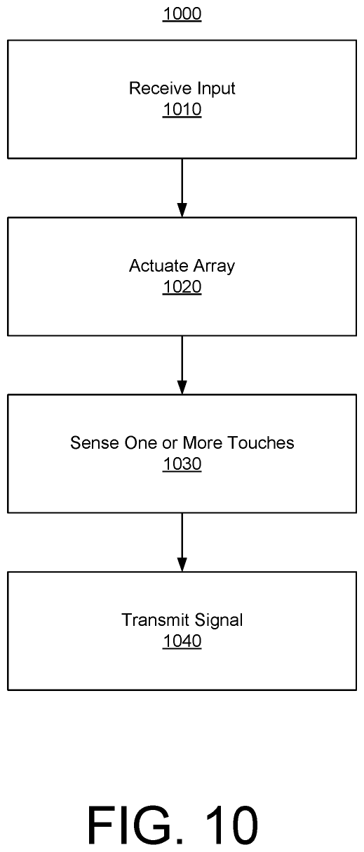

FIG. 10 shows an example of a method 1000 that can include a reception block 1010 for receiving input, an actuating block 1020 for actuating an array responsive to the input, a sense block 1030 for sensing one or more touches, and a transmit block 1040 for transmitting output responsive to the sensing. For example, the output may be in accordance with a HID output such as, for example, a keyboard output receivable by a computing system. In the example of FIG. 10, the array may be actuating using one or more types of control circuitry (e.g., electrical, mechanical, fluidic, etc.).

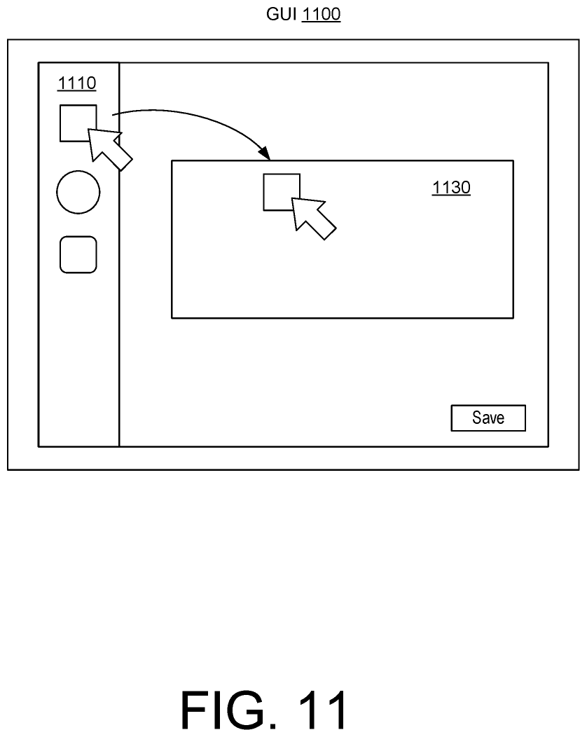

FIG. 11 shows an example of a GUI 1100 that may provide for customization of a device such as, for example, the device 200. In such an example, the GUI 1100 may include a field 1130 and a menu of shapes 1110 where one or more of the shapes may be dragged and dropped in the field 1130 to arrange a layout of keys. In such an example, the shapes may be customizable, for example, to be adjusted as to dimensions, aspect ratio, etc. In such an approach, the GUI 1100 may help a user or another individual customize a layout for the user. As an example, once a layout is created, it may be stored to memory (see, e.g., a “Save” graphic control), which may be memory of a device such as, for example, the device 200. In such an example, the created layout may be a single layout of the device or one of two or more layouts that may be selectable for generation as keys. As an example, a save operation may provide for associating a layout with a particular instantiation key, voice command, etc. As to a voice command, such an approach may assist a sight impaired individual in instantiating a layout as may be saved and associated with the voice command.

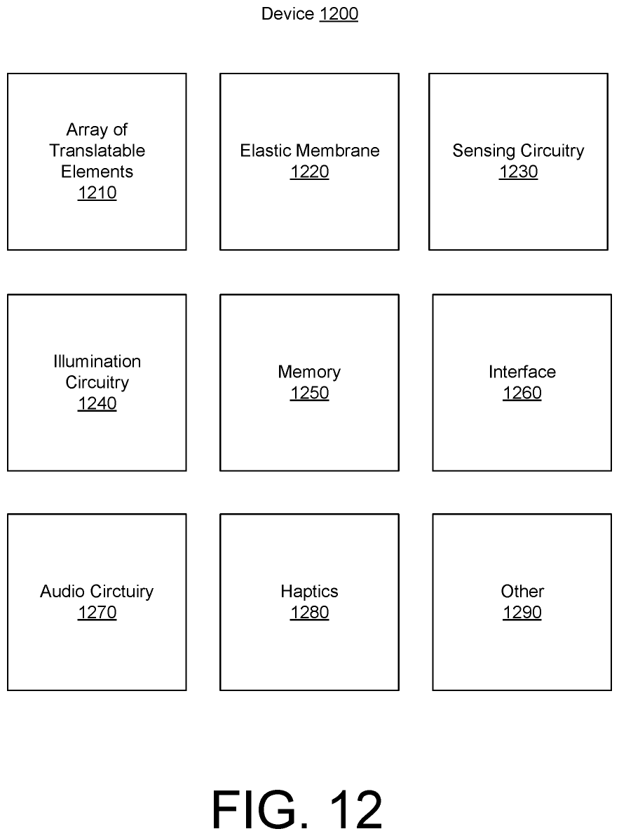

FIG. 12 shows a block diagram of a device 1200 that may include one or more components as represented by blocks. As shown, the device 1200 may include an array of translatable elements 1210, an elastic membrane 1220, sensing circuitry 1230, illumination circuitry 1240, memory 1250, an interface 1260, audio circuitry 1270, haptics 1280, and one or more other components 1290 (e.g., controller circuitry, etc.).

As an example, a device may include controller circuitry, such as, for example, controller circuitry that includes one or more features of a keyboard or keypad controller. For example, consider the ADP5588 mobile I/O expander and QWERTY keypad controller, which includes an 18-GPIO port expander or 10 by 8 keypad matrix GPIOs configurable to GPIs, GPOs, and keypad rows or columns, along with dual light sensor inputs and an I2C interface (e.g., I2C interface). A data sheet for the ADP5588 circuitry, D07673-0-10/19 (D) (Rev. D), of Analog Devices, Inc. (Wilmington, MA), is incorporated by reference herein in its entirety. Such circuitry may provide for any number of rows and columns to be configured to be part of a matrix where, for example, rows and columns that make up the matrix may be configured by setting corresponding bits in registers. While a 10 by 8 matrix is mentioned, a matrix may be of an appropriate size to accommodate customization of an HID. As an example, an HID may include a number of matrixes to accommodate customization of an HID.

As an example, a device may include one or more associated drivers. For example, consider a driver as executable instructions that may provide for interoperability between a device such as the device 1200 and a computing device. In such an example, a driver may be executed by the device and/or the computing device. As an example, a device may be a smart device that includes one or more processors and memory that can execute instructions that provide for customization of keys of the device where, for example, output may be suitably mapped and/or otherwise translated to instructions receivable by a computing device (e.g., via a wired interface and/or via a wireless interface).

As to the array of translatable elements 1210, such an array may be actuatable using one or more technologies. For example, consider one or more of fluid (e.g., microfluidics), electrical, mechanical, etc.

As to an example of an electro-mechanical array, consider solenoid coils (e.g., four layers of about 80 windings per layer to provide a sufficiently high magnetic force while maintaining low current draw). In such an example, a diameter of a solenoid may match an approximately 1 mm diameter of a permanent neodymium (NdFeB) magnet. In such an example, the 1 mm diameter may be arranged in an array to resemble standard braille dimensions. As an example, a relatively low-density polyethylene (LDPE) film may be utilized as an elastic membrane. For example, an elastic membrane may be a sufficiently flexible surface layer that allows a user to feel protrusions in an “on” state of a solenoid where the elastic membrane may also retract in an “off” state of a solenoid due to magnetic force. In such an example, the array may be customizable and include a number of sub-arrays, which may, for example, be 2×3 braille sub-arrays such that markers may be generated according to the braille alphabet or, for example, 7-segment sub-arrays.

As an example, a membrane may be made of one or more polymeric materials and may be provided in a continuous form, a mesh form, a perforated form, etc. As an example, a membrane may be configured to provide appropriate elastic properties such that an array of translatable elements can elastically deform the membrane. As an example, a membrane may include one or more materials that may be active when exposed to a magnetic field, an electrical field, an electromagnetic field, etc. For example, electromagnetic radiation as emitted by one or more components may provide for alteration of one or more properties of a membrane (e.g., elastic, optical, etc.).

As an example, a single translatable element may provide force sufficient to elastically deform an elastic membrane and, for example, to resist force applied by the elastic membrane, which may be a spring like force that acts to push a translatable element downwardly. As an example, an array may be configured with respect to various forces, which may include an elastic membrane force, a touch force (e.g., from a user's finger or fingers, which may include a thumb or thumbs), etc.

In the foregoing electro-mechanical array example, a solenoid may be coupled with one or more LEDs and/or lightpipes. In such an example, each solenoid may effectively be a pixel that can be illuminated to generate a marker. For example, upon energizing a solenoid to cause a magnet to translate, an LED may be actuated where the solenoid may act as a light guide to guide light to the elastic membrane to cause a portion of to illuminate; noting that the elastic membrane may be transparent or opaque with some amount of an ability to transmit light.

As to a segment type of array, in a solenoid approach, a segment may be coupled to a magnet such that translation of the magnet causes the segment to rise or lower. As an example, a segment may be made of a material that transmits light. For example, consider a polymeric material that may carry light such that the segment may illuminate and provide for Siekoo alphabet marker output.

As an example, a solenoid type of array may generate a signal responsive to touch that causes movement of a magnet. For example, consider applying force using a finger where the force is sufficient to cause the magnet or magnets to translate downwardly, which may be registered by one or more coils (e.g., solenoid coils) such that actuation can be sensed (e.g., detected). In such an example, the magnet or magnets, once the touch force is removed, may spring back to an extended position that extends an elastic membrane to form a key or keys.

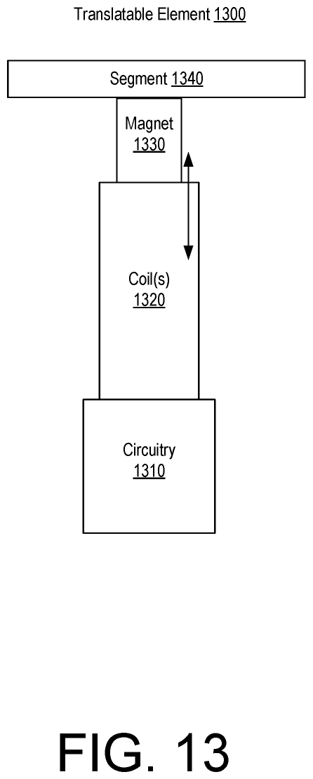

FIG. 13 shows an example of a translatable element 1300 that includes circuitry 1310 (e.g., control circuitry) operatively coupled to one or more coils 1320 that can cause translation of a magnet 1330 along an axis (e.g., a z-axis, etc.). In such an example, the magnet 1330 may be translatable at least in part within a bore of the one or more coils 1320, noting that one or more other arrangements of magnets and/or coils may be utilized. As an example, the translatable element 1300 may include a spring such as a coil spring, which may bias the magnet 1330 in a direction or directions. In such an approach, a current provided to the one or more coils 1320 may be suitable adjusted (e.g., for actuation, retraction, response to touch, etc.). In the example of FIG. 13, the translatable element 1300 may include a segment 1340, which may, for example, be coupled to the magnet 1330 such that translation of the magnet 1330 causes translation of the segment 1340. As explained, a segment may be utilized in a segment type of array, which may be or include a 7-segment type of array for generation of 7-segment markers (e.g., Siekoo alphabet, etc.).

In the example of FIG. 13, the circuitry 1310 may include LED circuitry or other light emitting circuitry. As explained, upon actuation, an LED may generate light that may be directed toward an elastic membrane to thereby form a marker, which may be indicative of function of a key. In the example of FIG. 13, a clearance may exist between the magnet 1330 and a borewall of the one or more coils 1320 such that light may emanate outwardly toward an elastic membrane. As an example, the magnet 1330 may include a bore where light may travel through the bore to illuminate an elastic membrane.

As an example, an LED may be a controllable LED as to one or more features thereof. For example, consider an LED that may be controllable as to brightness, hue, etc., where color may be controllable according to one or more color spaces (e.g., RGB, etc.). As an example, a device may include one or more LEDs that emit light in an ultraviolet (UV) range. In such an example, the UV light may provide for one or more functions. For example, consider a sanitary function where the UV light may help to sanitize a surface (e.g., a membrane). As another example, consider a membrane and/or another component or components of a device that may include material that fluoresces upon exposure to UV light. In such an example, the UV light may selectively cause a material to fluoresce, which may be visible to a user, for example, to guide a user and/or to provide a marker indicative of one or more functions of a key or keys. As an example, UV light may be selectively emitted by one or more LEDs and absorbed by one or more materials where the one or more materials may provide for emissions at a longer wavelength that corresponds to visible radiation (e.g., visible light). Such a phenomenon may be referred to as UV-induced visible fluorescence. As an example, an elastic membrane, a segment, etc., may include a material or materials that fluoresce upon exposure to UV light. In such an example, one or more patterns may be generated for viewing by a user of a device.

As an example, an elastic membrane may be physically coupled to an end of a translatable element or may rest over an end of a translatable element; noting that an end may be a segment or not. As explained, a translatable element may act as an anchor where, for example, an elastic membrane is physically coupled to the end (e.g., via adhesive, a connector, etc.). As an example, a key may be formed with or without physical coupling of an elastic membrane to a translatable element, which may depend on draping characteristics of the elastic membrane. For example, if the elastic membrane drapes sufficiently downwardly from an extended translatable element, a key may be suitably formed and discernable to a user, whether visually and/or tactilely. As an example, an elastic membrane may be a mesh where properties of the mesh may be tailored for a particular type of array, use cases, customizability, etc.

As explained, a translatable element may be actuated to extend to form a key and deactuated to retract to not form a key. As explained, a translatable element may be responsive to touch such that upon touch by a finger of a user, the translatable element may generate a signal, which may be a keystroke signal.

As to sensing circuitry, as mentioned, a coil or coils may be utilized. As an example, sensing circuitry may utilize a Hall effect sensor (e.g., a Hall sensor). For example, consider a sensor that may detects presence and/or magnitude of a magnetic field using the Hall effect. In such an example, an output voltage of a Hall sensor may be directly proportional to the strength of the field. As an example, where a translatable element includes a translatable magnet, movement of the magnet responsive to a touch force may be sensed using a Hall sensor. As an example, sensing circuitry may include one or more of an inductive sensor that may sense movement of a magnet and/or a Hall sensor that may sense movement of a magnet. As an example, sensing circuitry may include one or more electrical contact sensors where, for example, upon movement due to application of force by a hand, two electrically conductive surfaces are brought into contact.

As an example, sensing circuitry may provide for capacitive touch sensing and/or another type of touch sensing. In various examples, a key may be depressible such that a user can tactilely determine whether or not touch actuates a key. As an example, a key may be sufficiently resilient to maintain weight or force of a finger that rests thereupon without the key being unintentionally actuated. While a finger or fingers are mentioned, as an example, a key or keys may be actuatable by a portion of a hand. For example, consider an individual with limited movement of fingers in one or both hands where a rolling motion of a hand (e.g., backward, forward, sideways, etc.) may cause a portion of a palm or a side of a hand to contact a key or keys to thereby actuate the key or keys.

In various examples, actuation of a key may be detected by sensing circuitry associated with one or more translatable elements. For example, given a character key formed by three segments, one or more of the segments may provide for detecting actuation. As an example, where multiple translatable elements are utilized, sensing of intentional actuation may be more robust. For example, consider a user that may accidently contact and slightly depress a translatable element of an adjacent key when intentionally actuating a key. In such an example, if that translatable element, by itself, does not indicate actuation, a device may disregard such accidently input as being unintentional. In contrast, where multiple translatable elements of a key are actuated, that may provide an indication of intentional actuation of the key where, for example, the more that are actuated, the higher the confidence (e.g., probability) that actuation is intentional. Such an approach may provide for improved touch-typing compared to a keyboard that may have a single actuator for each key. Further, multiple translatable elements for use in sensing may provide for redundancy, for example, if a translatable element may be failing or have failed as to its ability to provide for sensing responsive to application of a touch force.

As an example, an array may be electronically controlled through use of one or more types of circuitry. For example, consider a microcontroller that includes a number of channels to control translatable elements of an array.

As an example, a device may be a customizable HID, which may include an elastic membrane for forming keys such as, for example, keys of a keyboard. As an example, such a device may be independently or via operative coupling to another device, dynamically and programmatically configured to construct a variable keyboard layout and design. In such an example, the device may allow users with limited arm mobility, hand dexterity, etc., to adjust a keyboard to their advantage. As an example, a customizable HID may allow different business domains to leverage various proprietary layouts to suit their needs.

As an example, a device can include an elastic membrane; an array that includes translatable elements extendable to elastically deform the elastic membrane to form a customizable arrangement of discrete keys; and sensor circuitry that senses actuation of each of the discrete keys.

As an example, a translatable element may include a spring, which may be a coil spring, a magnetic spring, a fluid spring or a combination of one or more types of springs. As to a fluid spring, it may utilize one or more types of fluids such as, for example, gas and/or liquid fluids. As an example, a fluid spring may be pneumatic and/or hydraulic.

As an example, sensor circuitry, which may be referred to as sensing circuitry, may include electronic circuitry, electromagnetic circuitry, and/or one or more other types of circuitry.

As an example, a device may include memory that stores data for automatically extending a number of translatable elements to form a customizable arrangement of discrete keys. In such an example, the memory may store data for a plurality of customizable arrangements of discrete keys. In such an example, the device may include buttons for selection of one of the plurality of customizable arrangements of discrete keys and/or may include one or more types of circuitry that may respond to a voice command (e.g., consider audio circuitry, which may include a microphone).

As an example, an array may be or include a dot array where, for example, the dot array includes illuminable elements for identification of functions of one or more discrete keys.

As an example, an array may be or include a bar array, which may be referred to as a segment array. In such an example, the bar array may include illuminable elements for identification of functions of one or more discrete keys. As an example, a bar array may include bars that can represent elements of the Siekoo alphabet. As an example, an array may include illuminable elements that can provide for illuminated elements of the Siekoo alphabet.

As an example, a device can include discrete keys that may have customizable shapes. As an example, a GUI may be provided that allows for customization of such shapes.

As an example, a customizable arrangement of discrete keys may include discrete keys of a QWERTY keyboard and/or discrete keys of a numeric keypad; noting that other types of discrete keys may be included.

As an example, a method can include receiving input; responsive to the input, extending translatable elements of an array to form an arrangement of discrete keys; sensing one or more touches of one or more of the discrete keys; and responsive to the sensing, outputting a signal. In such an example, the outputting a signal may output a signal to a computing device that translates the signal to one or more characters renderable to a display. For example, consider a word processing application that may be utilized to type characters in a document, etc.

As an example, a computer program product can include instructions to instruct a computing device, a computing system, etc., to perform one or more methods.

The term “circuit” or “circuitry” is used in the summary, description, and/or claims. As is well known in the art, the term “circuitry” includes all levels of available integration (e.g., from discrete logic circuits to the highest level of circuit integration such as VLSI, and includes programmable logic components programmed to perform the functions of an embodiment as well as general-purpose or special-purpose processors programmed with instructions to perform those functions) that includes at least one physical component such as at least one piece of hardware. A processor can be circuitry. Memory can be circuitry. Circuitry may be processor-based, processor accessible, operatively coupled to a processor, etc. Circuitry may optionally rely on one or more computer-readable media that includes computer-executable instructions. As described herein, a computer-readable medium may be a storage device (e.g., a memory chip, a memory card, a storage disk, etc.) and referred to as a computer-readable storage medium, which is non-transitory and not a signal or a carrier wave.

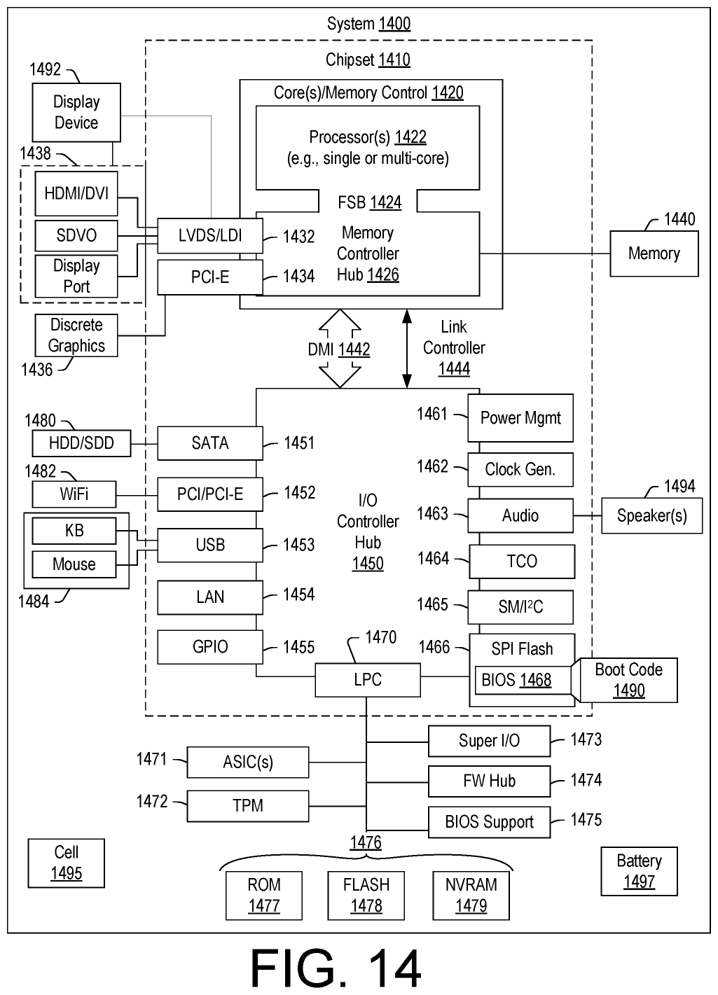

While various examples of circuits or circuitry have been discussed, FIG. 14 depicts a block diagram of an illustrative computer system 1400. The system 1400 may be a computer system, such as one of the ThinkCentre® or ThinkPad® series of personal computers sold by Lenovo (US) Inc. of Morrisville, NC, or a workstation computer system, such as the ThinkStation®, which are sold by Lenovo (US) Inc. of Morrisville, NC; however, as apparent from the description herein, a system or other machine may include other features or only some of the features of the system 1400.

As shown in FIG. 14, the system 1400 includes a so-called chipset 1410. A chipset refers to a group of integrated circuits, or chips, that are designed (e.g., configured) to work together. Chipsets are usually marketed as a single product (e.g., consider chipsets marketed under the brands INTEL, AMD, etc.).

In the example of FIG. 14, the chipset 1410 has a particular architecture, which may vary to some extent depending on brand or manufacturer. The architecture of the chipset 1410 includes a core and memory control group 1420 and an I/O controller hub 1450 that exchange information (e.g., data, signals, commands, etc.) via, for example, a direct management interface or direct media interface (DMI) 1442 or a link controller 1444. In the example of FIG. 14, the DMI 1442 is a chip-to-chip interface (sometimes referred to as being a link between a “northbridge” and a “southbridge”).

The core and memory control group 1420 include one or more processors 1422 (e.g., single core or multi-core) and a memory controller hub 1426 that exchange information via a front side bus (FSB) 1424. As described herein, various components of the core and memory control group 1420 may be integrated onto a single processor die, for example, to make a chip that supplants the conventional “northbridge” style architecture.

The memory controller hub 1426 interfaces with memory 1440. For example, the memory controller hub 1426 may provide support for DDR SDRAM memory (e.g., DDR, DDR2, DDR3, etc.). In general, the memory 1440 is a type of random-access memory (RAM). It is often referred to as “system memory”.

The memory controller hub 1426 further includes a low-voltage differential signaling interface (LVDS) 1432. The LVDS 1432 may be a so-called LVDS Display Interface (LDI) for support of a display device 1492 (e.g., a CRT, a flat panel, a projector, etc.). A block 1438 includes some examples of technologies that may be supported via the LVDS interface 1432 (e.g., serial digital video, HDMI/DVI, display port). The memory controller hub 1426 also includes one or more PCI-express interfaces (PCI-E) 1434, for example, for support of discrete graphics 1436. Discrete graphics using a PCI-E interface has become an alternative approach to an accelerated graphics port (AGP). For example, the memory controller hub 1426 may include a 16-lane (x16) PCI-E port for an external PCI-E-based graphics card. A system may include AGP or PCI-E for support of graphics. As described herein, a display may be a sensor display (e.g., configured for receipt of input using a stylus, a finger, etc.). As described herein, a sensor display may rely on resistive sensing, optical sensing, or other type of sensing.

The I/O hub controller 1450 includes a variety of interfaces. The example of FIG. 14 includes a SATA interface 1451, one or more PCI-E interfaces 1452 (optionally one or more legacy PCI interfaces), one or more USB interfaces 1453, a LAN interface 1454 (more generally a network interface), a general purpose I/O interface (GPIO) 1455, a low-pin count (LPC) interface 1470, a power management interface 1461, a clock generator interface 1462, an audio interface 1463 (e.g., for speakers 1494), a total cost of operation (TCO) interface 1464, a system management bus interface (e.g., a multi-master serial computer bus interface) 1465, and a serial peripheral flash memory/controller interface (SPI Flash) 1466, which, in the example of FIG. 14, includes BIOS 1468 and boot code 1490. With respect to network connections, the I/O hub controller 1450 may include integrated gigabit Ethernet controller lines multiplexed with a PCI-E interface port. Other network features may operate independent of a PCI-E interface.

The interfaces of the I/O hub controller 1450 provide for communication with various devices, networks, etc. For example, the SATA interface 1451 provides for reading, writing or reading and writing information on one or more drives 1480 such as HDDs, SDDs or a combination thereof. The I/O hub controller 1450 may also include an advanced host controller interface (AHCI) to support one or more drives 1480. The PCI-E interface 1452 allows for wireless connections 1482 to devices, networks, etc. The USB interface 1453 provides for input devices 1484 such as keyboards (KB), one or more optical sensors, mice and various other devices (e.g., microphones, cameras, phones, storage, media players, etc.). On or more other types of sensors may optionally rely on the USB interface 1453 or another interface (e.g., I2C, etc.). As to microphones, the system 1400 of FIG. 14 may include hardware (e.g., audio card) appropriately configured for receipt of sound (e.g., user voice, ambient sound, etc.).

In the example of FIG. 14, the LPC interface 1470 provides for use of one or more ASICs 1471, a trusted platform module (TPM) 1472, a super I/O 1473, a firmware hub 1474, BIOS support 1475 as well as various types of memory 1476 such as ROM 1477, Flash 1478, and non-volatile RAM (NVRAM) 1479. With respect to the TPM 1472, this module may be in the form of a chip that can be used to authenticate software and hardware devices. For example, a TPM may be capable of performing platform authentication and may be used to verify that a system seeking access is the expected system.

The system 1400, upon power on, may be configured to execute boot code 1490 for the BIOS 1468, as stored within the SPI Flash 1466, and thereafter processes data under the control of one or more operating systems and application software (e.g., stored in system memory 1440). An operating system may be stored in any of a variety of locations and accessed, for example, according to instructions of the BIOS 1468. Again, as described herein, a satellite, a base, a server or other machine may include fewer or more features than shown in the system 1400 of FIG. 14. Further, the system 1400 of FIG. 14 is shown as optionally include cell phone circuitry 1495, which may include GSM, CDMA, etc., types of circuitry configured for coordinated operation with one or more of the other features of the system 1400. Also shown in FIG. 14 is battery circuitry 1497, which may provide one or more battery, power, etc., associated features (e.g., optionally to instruct one or more other components of the system 1400). As an example, a SMBus may be operable via a LPC (see, e.g., the LPC interface 1470), via an I2C interface (see, e.g., the SM/I2C interface 1465), etc.

Although examples of methods, devices, systems, etc., have been described in language specific to structural features and/or methodological acts, it is to be understood that the subject matter defined in the appended claims is not necessarily limited to the specific features or acts described. Rather, the specific features and acts are disclosed as examples of forms of implementing the claimed methods, devices, systems, etc.

1. A device comprising:
an elastic membrane;
an array that comprises translatable elements extendable to elastically deform the elastic membrane to form a customizable arrangement of discrete keys; and
sensor circuitry that senses actuation of each of the discrete keys.

2. The device of claim 1, wherein each of the translatable elements comprises a spring.

3. The device of claim 2, wherein the spring comprises a coil spring.

4. The device of claim 2, wherein the spring comprises a magnetic spring.

5. The device of claim 2, wherein the spring comprises a fluid spring.

6. The device of claim 1, wherein the sensor circuitry comprises electronic circuitry.

7. The device of claim 1, wherein the sensor circuitry comprises electromagnetic circuitry.

8. The device of claim 1, comprising memory that stores data for automatically extending a number of the translatable elements to form the customizable arrangement of discrete keys.

9. The device of claim 8, wherein the memory stores data for a plurality of customizable arrangements of discrete keys.

10. The device of claim 9, comprising buttons for selection of one of the plurality of customizable arrangements of discrete keys.

11. The device of claim 1, wherein the array comprises a dot array.

12. The device of claim 11, wherein the dot array comprises illuminable elements for identification of functions of one or more of the discrete keys.

13. The device of claim 1, wherein the array comprises a bar array.

14. The device of claim 13, wherein the bar array comprises illuminable elements for identification of functions of one or more of the discrete keys.

15. The device of claim 14, wherein the illuminable elements comprise elements of the Siekoo alphabet.

16. The device of claim 1, wherein the discrete keys comprise customizable shapes.

17. The device of claim 1, wherein the customizable arrangement comprises discrete keys of a QWERTY keyboard.

18. The device of claim 1, wherein the customizable arrangement comprises discrete keys of a numeric keypad.

19. A method comprising:
receiving input to form a customized arrangement of discrete keys from a plurality of different customized arrangements of discrete keys;
responsive to the input, extending some translatable elements of an array to form the customized arrangement of discrete keys, wherein some other translatable elements of the array are not extended;
sensing one or more touches of one or more of the discrete keys; and
responsive to the sensing, outputting a signal.

20. The method of claim 19, wherein the outputting a signal outputs a signal to a computing device that translates the signal to one or more characters renderable to a display.
